(19) United States
(12) Patent Application Publication
(10) Pub. No.: US 2026/0154019 A1
(43) Pub. Date: Jun. 4, 2026

(54) SERVER, FUNCTION EXECUTING DEVICE, COMMUNICATION SYSTEM, NON-TRANSITORY COMPUTER-READABLE STORAGE MEDIUM STORING COMPUTER-READABLE INSTRUCTIONS FOR SERVER, AND NON-TRANSITORY COMPUTER-READABLE STORAGE MEDIUM STORING COMPUTER-READABLE INSTRUCTIONS FOR FUNCTION EXECUTING DEVICE

(71) Applicant: BROTHER KOGYO KABUSHIKI KAISHA, Nagoya (JP)

(72) Inventor: Yuki YADA, Kuwana (JP)

(21) Appl. No.: 19/398,308

(22) Filed: Nov. 24, 2025

(30) Foreign Application Priority Data
Nov. 29, 2024 (JP) 2024-208291

(51) Int. Cl. G06F 3/12

(52) U.S. Cl. CPC G06F 3/1239; G06F 3/1203; G06F 3/123; G06F 3/1273; G06F 3/1286; G06F 3/1287

(57) ABSTRACT

A server may receive, from each of one or more function executing devices, history information representing an execution history of a specific function executable by the function executing device. The server may specify a target function executing device from among the one or more function executing devices based on the history information received from each of the one or more function executing devices, wherein the target function executing device has an execution frequency of the specific function that is less than or equal to a predetermined threshold. The server may send a restriction instruction for restricting execution of the specific function to the target function executing device, wherein the restriction instruction is not sent to other function executing devices among the one or more function executing devices other than the target function executing device.

### REFERENCE TO RELATED APPLICATION

This application claims priority to Japanese Patent Application No. 2024-208291 filed on Nov. 29, 2024. The entire content of the priority application is incorporated herein by reference.

### BACKGROUND ART

A remote management system is known where a management device sends, to electronic devices, software for electronic device update. In this remote management system, the management device sends the software to a mediation device. Then, the mediation device, after having received the software, sends the software to electronic devices that require software update therein.

### SUMMARY

The disclosure herein provides teachings for appropriately restricting execution of a specific function.

A server is disclosed herein. The server may include a controller. The controller may be configured to receive, from one or more function executing devices, history information representing an execution history of a specific function executable by each of the one or more function executing devices. The controller may be configured to determine a target function executing device from among the one or more function executing devices based on the history information received from each of the one or more function executing devices. The target function executing device has an execution frequency of the specific function that is less than or equal to a predetermined threshold. The execution frequency is a frequency at which the specific function is executed. The controller may be configured to send a restriction instruction for imposing a restriction on execution of the specific function to the target function executing device. The restriction instruction is not sent to other function executing devices except for the target function executing device among the one or more function executing devices.

According to the configuration above, the server receives, from each of the one or more function executing devices, the history information representing the execution history of the specific function and then determines the target function executing device in which the execution frequency of the specific function is less than or equal to the predetermined threshold, based on the history information. Then, the server sends the restriction instruction to the target function executing device and does not send the restriction instruction to the other function executing devices except for the target function executing device. That is, the server sends the restriction instruction to the target function executing device in which the specific function is executed at a relatively low frequency and does not send the restriction instruction to the function executing devices in which the specific function is executed at a relatively high frequency. Thus, the server can appropriately restrict execution of the specific function.

A function executing device is also disclosed herein. The function executing device may include a controller. The controller may be configured to send history information representing an execution history of a specific function executable by the function executing device to a server. The controller may be configured to, in a case where the server determines that an execution frequency of the specific function is less than or equal to a predetermined threshold based on the history information, receive a restriction instruction for restricting execution of the specific function from the server. The controller may be configured to, in response to receiving the restriction instruction from the server, restrict execution of the specific function.

According to the configuration above, the function executing device sends the history information representing its execution history of the specific function to the server. In the case where the server determines that an execution frequency of the specific function is less than or equal to the predetermined threshold, the function executing device receives the restriction instruction from the server. In the case where the function executing device receives the restriction instruction from the server, the function executing device restricts execution of the specific function. Thus, the function executing device can appropriately restrict execution of the specific function.

A communication system is also disclosed herein. The communication system may include a server and one or more function executing devices. Each of the one or more function executing devices may include a device controller. The device controller may be configured to send history information representing an execution history of a specific function executable by the function executing device to the server. The server may include a server controller. The server controller may be configured to receive the history information from each of the one or more function executing devices. The server controller may be configured to determine a target function executing device from among the one or more function executing devices based on the history information received from each of the one or more function executing devices. The target function executing device has an execution frequency of the specific function that is less than or equal to a predetermined threshold. The execution frequency is a frequency at which the specific function is executed. The server controller may be configured to send a restriction instruction for restricting execution of the specific function to the target function executing device, wherein the restriction instruction is not sent to other function executing devices except for the target function executing device among the one or more function executing devices. The target function executing device may include a target device controller. The target device controller may be configured to receive the restriction instruction from the server. The target device controller may be configured to, in response to receiving the restriction instruction from the server, restrict execution of the specific function.

According to the configuration above, the server receives, from each of the one or more function executing devices, the history information representing an execution history of the specific function and determines the target function executing device in which the execution frequency of the specific function is less than or equal to the predetermined threshold, based on the history information. Then, the server sends the restriction instruction to the target function executing device and does not send the restriction instruction to other function executing devices except for the target function executing device. That is, the server sends the restriction instruction to the function executing device in which the specific function is executed at a relatively low frequency and does not send the restriction instruction to the function executing devices in which the specific function is executed at a relatively high frequency. Then, the target function executing device, after receiving the restriction instruction from the server, restricts execution of the specific function. Thus, execution of the specific function can be appropriately restricted.

Computer-readable instructions for the above server, a non-transitory computer-readable storage medium storing the computer-readable instructions, and methods performed by the server are also novel and useful. Computer-readable instructions for the above function executing device, a non-transitory computer-readable storage medium storing the computer-readable instructions, and methods performed by the function executing device are also novel and useful. Each of the above storage media may be a single medium or a combination of multiple media.

### BRIEF DESCRIPTION OF DRAWINGS

FIG. 1 is a schematic diagram of a communication system.

FIG. 2 is a block diagram for illustrating hardware of each device.

FIG. 3 is a sequence diagram illustrating a specific process.

FIG. 4 is a sequence diagram illustrating a specific process.

FIG. 5 is a sequence diagram illustrating a specific process.

### DESCRIPTION

### First Embodiment

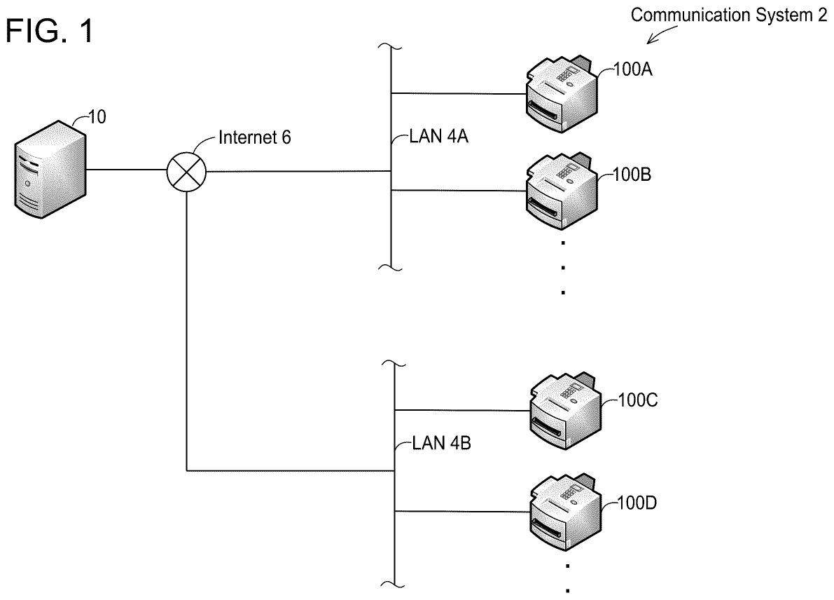

### Configuration of Communication System 2: FIG. 1

As illustrated in FIG. 1, a communication system 2 comprises a server 10 and a plurality of printers 100A to 100D. Hereinafter, the printers 100A to 100D may be collectively termed “the printers 100”.

The server 10 is connected to the internet 6. The printers 100A, 100B are connected to a local area network (LAN) 4A, and the printers 100C, 100D are connected to a LAN 4B different from the LAN 4A. The LANs 4A, 4B may be wired LANs or wireless LANs. The LANs 4A, 4B are connected to the internet 6. The server 10 is communicable with the printers 100A, 100B via the internet 6 and the LAN 4A. The server 10 is communicable with the printers 100C, 100D via the internet 6 and the LAN 4B. An area where the LAN 4A is present may be the same as or different from an area where the LAN 4B is present. For example, the area may be a company office. This embodiment exemplifies a case where the LAN 4A and LAN 4B are different networks, but are present in the same office.

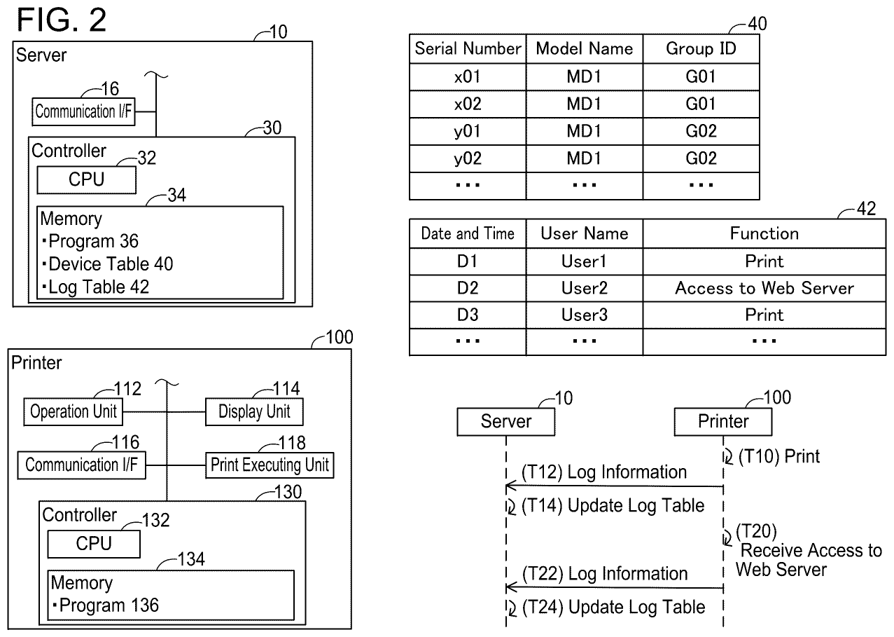

### Hardware Configuration of Each Device: FIG. 2

Now referring to FIG. 2, hardware configurations of the devices 10, 100, which constitute the communication system 2, are described.

### Configuration of Server 10

The server 10 manages a plurality of printers including the printers 100A to 100D. The server 10 comprises a communication interface 16 and a controller 30. Hereinafter, an interface is abbreviated as “I/F”. The communication I/F 16 is connected to the internet 6. The controller 30 controls elements of the server 10, including the communication I/F 16. The communication I/F 16 and the controller 30 are connected to a bus line.

The controller 30 comprises a CPU 32 and a memory 34. The memory 34 comprises a main storage and an auxiliary storage. The main storage includes a RAM and a cache memory, although this is merely an example. The auxiliary storage may be a ROM, a flush memory, a solid state drive (SSD), a hard disk drive (HDD), or a combination thereof, although this is merely an example. A program 36 is stored in the auxiliary storage of the memory 34. The CPU 32 executes various processes according to the program 36 loaded from the auxiliary storage to the main storage.

A device table 40 and log tables 42 are also stored in the memory 34. The device table 40 stores information of multiple printers therein. The device table 40 stores, for each of the multiple printers, the serial number identifying the printer, the model name of the printer, and a group ID identifying a group the printer belongs to, in association with each other. In this embodiment, as illustrated in FIG. 2, information of at least four printers is stored in the device table 40. Serial numbers “x01”, “x02”, “y01”, “y02” are information identifying the printer 100A, 100B, 100C, 100D, respectively. The printers 100A, 100B connected to the LAN 4A belong to a group identified by a group ID “G01”. The printers 100C, 100D connected to the LAN 4B belong to a group identified by a group ID “G02”.

An administrator of the office where the printers 100 are installed or a business operator that installed the printers 100 in the office registers the serial numbers and the model names of the printers 100A to 100D in the device table 40. Further, the administrator or the business operator assigns a group ID to each of the printers 100A to 100D and registers the group IDs in the device table 40. In a modification, an administrator of the server 10 may assign group IDs to the printers. As described above, in this embodiment, the group ID assigned to the printers 100A, 100B connected to the LAN 4A is different from the group ID assigned to the printers 100C, 100D connected to the LAN 4B. In a modification, the same group ID may be assigned to the printers 100A to 100D since the printers 100A to 100D are installed in the same office.

Each log table 42 stores log entries (hereinafter referred to as log information) representing a usage history of a corresponding printer. That is, the server 10 stores, for each of printers, a log table 42 associated with the serial number of the printer. FIG. 2 illustrates a log table 42 associated with the serial number “x01” of the printer 100A. Each log entry stored in a log table 42 includes the date and time at which the printer was used, a user name of a user who used the printer, and information indicating a function used in the printer. In a modification, each log entry may further include the serial number of the printer used, in addition to the information listed above. In this modification, the server 10 may store only a single log table for all printers collectively, instead of storing separate log tables for the respective printers.

Referring to FIG. 2, how a log table 42 is updated is described. First, a printer 100 (i.e., any one of the printers 100A to 100D) executes printing in response to receiving an instruction from a particular user in T10. Exemplified herein is a case where the printer 100A executes printing in response to receiving an instruction from a user with a user name “User1”. In this case, the printer 100A sends log information and the serial number “x01” to the server 10 in T12. This log information includes the date and time at which the printing was executed, the user name “User1”, and information indicating the execution of printing.

In response to receiving the log information and the serial number “x01” from the printer 100A in T12, the server 10 updates the log table 42 in T14. Specifically, the server 10 first identifies the log table 42 associated with the received serial number “x01”. The server 10 then stores the received log information in that log table 42. That is, the server 10 stores the date and time, the user name “User1”, and the function “print”, which are included in the log information, in association with each other in the log table 42.

Then, a printer 100 functioning as a web server is accessed by a particular user in T20. Exemplified herein is a case where the printer 100A functioning as a web server is accessed by a user with a user name “User2”. In this case, the printer 100A sends log information and the serial number “x01” to the server 10 in T22. This log information includes the date and time at which the printer 100A was accessed, the user name “User2”, and information indicating the access to the web server.

In response to receiving the log information and the serial number “x01” from the printer 100A in T22, the server 10 updates the log table 42 in T24. T24 is the same as T14 except for the contents of log information to be stored.

As described above, the server 10 can store log information representing usage histories of the printers 100. In the example above, log information is sent from each of the printers 100 to the server 10 every time the printers 100 are used. In a modification, the printers 100 may store log information in their memories 134 every time the printers 100 are used, instead of sending log information to the server 10. Then, the printers 100 may send one or more log entries stored in the memories 134 altogether to the server 10 in response to a predetermined condition being satisfied (e.g., elapse of one hour).

The server 10 is established on the internet 6 by the vendor of the printers 100 (termed simply “the vendor” hereinafter). The server 10 may be a physical server, or may be a virtual server or virtual machine on the cloud. The server 10 may be a single server or a combination of multiple servers. The server 10 may be a server on an intranet or a cloud server on the internet 6. In a modification, the server 10 may be established on the internet 6 by a business operator different from the vendor. In another modification, the vendor does not prepare hardware for the server 10 and may instead use an environment provided by an external cloud computing service. In this case, the vendor may prepare a computer program (i.e., software) for the server 10 and install it to the above environment to implement the server 10. In this embodiment, the server 10 is a physical server, although this is merely an example.

### Configurations of Printers 100

The printers 100 are peripheral devices capable of executing a print function. In a modification, the printers 100 may be multifunctional devices capable of executing functions such as a scan function and a facsimile function, in addition to the print function. Each printer 100 comprises an operation unit 112, a display unit 114, a communication I/F 116, a print executing unit 118, and a controller 130. The units 112 to 130 are connected to a bus line.

The operation unit 112 is a user interface through which a user can input various types of information to the printer 100. The operation unit 112 comprises, for example, a touch screen for displaying software keys (operation objects), hardware keys, or both of them. The hardware keys include, for example, buttons or switches. The display unit 114 is a display or a panel for displaying various types of information. The panel may be or may not be a touch panel. Further, the panel is, for example, a liquid crystal panel or an organic EL panel. The communication I/F 116 is connected to the LAN 4A or the LAN 4B.

The print executing unit 118 is a print engine of inkjet, electrophotographic, or thermal type. A print engine of inkjet type comprises a print head configured to eject drops of ink. A print engine of electrophotographic type comprises, for example, a photosensitive drum and an exposure device configured to emit light to expose the photosensitive drum to the light. A print engine of thermal type comprises a print head configured to generate heat by a heater.

The controller 130 comprises a CPU 132 and a memory 134. The memory 134 comprises a main storage and an auxiliary storage. The main storage includes a RAM and a cache memory, although this is merely an example. The auxiliary storage may be a ROM, a flush memory, an SSD, an HDD, or a combination thereof, although this is merely an example. A program 136 is stored in the auxiliary storage of the memory 134. The CPU 132 executes various processes according to the program 136 loaded from the auxiliary storage to the main storage.

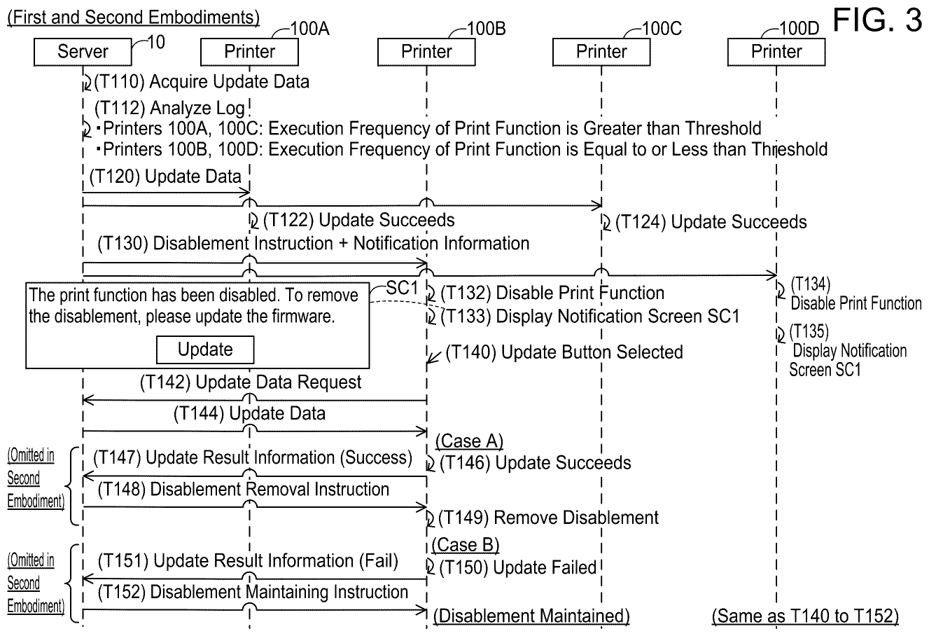

### Specific Process Executed by Devices: FIG. 3

Now referring to FIG. 3, a specific case is described. To facilitate understanding hereinafter, steps executed by the CPUs (e.g., 32, 132) of the devices (e.g., the server 10, the printers 100) are described as though the devices execute the steps. Further, since the devices communicate with each other via the communication I/Fs (e.g., 16, 116), a phrase “via the communication I/F” is omitted hereinafter in communication-related description.

In T110, the server 10 acquires update data. The update data is used for updating firmware of management target printers. The update data is provided to the server 10 from a firmware server established by the vendor of printers, for example, when a vulnerability in a certain function of the printer is found. That is, the server 10 acquires the update data from the firmware server in T110. The update data in the present case is data used to address a vulnerability in the print function of the printers. In a modification, the server 10 may acquire the update data in response to receiving the input of update data from the administrator of the server 10.

In T112, the server 10 executes a log analysis using the log tables 42. The log analysis in T112 is executed to calculate an execution frequency of a function corresponding to the update data in each of the multiple printers. The execution frequency is a frequency at which the function is executed. For example, when the update data is data used to address a vulnerability in the print function, the server 10 calculates an execution frequency of the print function in each printer. The server 10 changes information to be sent to each printer depending on the execution frequency, which will be detailed below. Specifically, the server 10 executes a process described below.

First, the server 10 identifies a single serial number in the device table 40. The server 10 then identifies the log table 42 associated with the identified serial number. After this, the server 10 identifies one or more log entries including the function “print” in the specified log table 42.

Then, the server 10 uses the one or more log entries to determine an execution frequency of the print function in the printer identified by the serial number. Specifically, the server 10 determines the number of log entries that include the dates and times within a predetermined period of time (e.g., within the latest one month) from among the one or more log entries. This number corresponds to the execution frequency of print function. Then, the server 10 determines whether the execution frequency of print function is greater than a threshold (e.g., 10 times).

The server 10 sequentially identifies all the serial numbers stored in the device table 40 and sequentially executes the above process. In the present case, the server 10 determines, for each of the four printers 100A to 100D, whether the execution frequency of print function therein is greater than the threshold. In the present case, the server 10 determines in T112 that the execution frequency of print function in two printers 100A and 100C is greater than the threshold, whereas the server 10 determines in T112 that the execution frequency of print function in two printers 100B and 100D is less than or equal to the threshold.

In T120, the server 10 sends the update data to the two printers 100A, 100C which have been determined as having the execution frequency of print function greater than the threshold. A disablement instruction, which will be described later, is not sent to the printers 100A, 100C.

In response to receiving the update data from the server 10 in T120, the printer 100A updates its firmware according to the update data. In the present case, the firmware update in the printer 100A succeeds in T122. Thus, the firmware in the printer 100A is successfully updated.

In response to receiving the update data from the server 10 in T120, the printer 100C updates its firmware according to the update data. In the present case, the firmware update in the printer 100C succeeds in T124. Thus, the firmware in the printer 100C is successfully updated.

In contrast, the server 10 does not send the update data to the two printers 100B, 100D which have been determined as having the execution frequency of print function less than or equal to the threshold. In T130, the server 10 sends a disablement instruction and notification information to the printers 100B, 100D. The disablement instruction is an instruction to disable the print function. Here, “disable the print function” means that a printer does not execute its print function in response to receiving a print instruction from a user. The notification information refers to information that represents a notification screen SC1, which will be described later.

The printer 100B receives the disablement instruction and the notification information from the server 10 in T130. In this case, the printer 100B disables the print function according to the disablement instruction in T132. That is, the printer 100B shifts to a state where the printer 100B does not execute the print function in response to receiving a print instruction from a user.

Further, the printer 100B displays a notification screen SC1 represented by the notification information on the display unit 114 in T133. The notification screen SC1 includes information indicating that the print function has been disabled. The notification screen SC1 further includes a message indicating that the firmware in the printer 100B needs to be updated in order to remove the disablement or re-enable print function. The notification screen SC1 further includes an update button for firmware update. By viewing the notification screen SC1, the user is able to know that the print function has been disabled and that the firmware needs to be updated in order to remove the disablement.

The printer 100D receives the disablement instruction and the notification information from the server 10 in T130. In this case, the printer 100D executes T134 and T135. T134 and T135 are the same as T132 and T133, respectively, except that it is the printer 100D that executes the steps.

In T140, the printer 100B receives selection of the update button in the notification screen SC1 from the user. In this case, the printer 100B sends an update data request to the server 10 in T142. The update data request is a signal that requests the server 10 to send the update data.

The server 10 receives the update data request from the printer 100B in T142. In response, the server 10 sends the update data to the printer 100B in T144.

The printer 100B receives the update data from the server 10 in T144. In response, the printer 100B updates its firmware according to the update data. As described above, the printer 100B sends the update data request to the server 10 in response to receiving selection of the update button. Thus, the printer 100B can receive the update data from the server 10 at the right time for update. Therefore, the printer 100B does not have to store the update data unnecessarily. Hereinafter, Case A where the update succeeds and Case B where the update fails will be described.

### Case A

First, Case A is described. In Case A, the firmware update in the printer 100B succeeds in T146. Thus, the firmware in the printer 100B is successfully updated. In this case, the printer 100B sends update result information indicating the success of firmware update to the server 10 in T147.

The server 10 receives the update result information indicating the success of firmware update from the printer 100B in T147. In response, the server 10 sends a disablement removal instruction to the printer 100B in T148. The disablement removal instruction is an instruction to remove the disablement of print function.

The printer 100B receives the disablement removal instruction from the server 10 in T148. In this case, the printer 100B removes the disablement in T149. That is, the printer 100B shifts to a state where the printer 100B executes the print function in response to receiving a print instruction from a user. As described above, the printer 100B can remove the disablement of print function.

### Case B

Next, Case B is described. In Case B, the firmware update in the printer 100B fails in T150. The failure of firmware update may be due to an insufficient space in the memory 134 of the printer 100B. In this case, the printer 100B sends update result information indicating the failure of firmware update to the server 10 in T151.

The server 10 receives the update result information indicating the failure of firmware update from the printer 100B in T151. In response, the server 10 sends a disablement maintaining instruction to the printer 100B in T152. The disablement maintaining instruction is an instruction to maintain the disablement of print function.

The printer 100B receives the disablement maintaining instruction from the server 10 in T152. In this case, the printer 100B maintains the disablement of print function. That is, the printer 100B maintains the state where the printer 100B does not execute the print function in response to receiving a print instruction from a user.

The sequence from T140 to T149 or the sequences from T140 to T144 and from T150 to T152 are also executed between the printer 100D and the server 10.

### Advantageous Effects of First Embodiment

According to the above configuration, the server 10 receives log information from each of the printers 100A to 100D (e.g., T12 and T22 in FIG. 2). The server 10 then determines, based on the log information, the printers 100B, 100D in which the execution frequency of print function is less than or equal to the threshold (T112 in FIG. 3). After that, the server 10 sends the disablement instruction to the printers 100B, 100D (T130), but does not send the disablement instruction to the printers 100A, 100C (see T120). That is, the server 10 sends the disablement instruction to the printers 100B, 100D in which the print function is executed at a relatively low frequency, but does not send the disablement instruction to the printers 100A, 100C in which the print function is executed at a relatively high frequency. After receiving the disablement instruction from the server 10, the printers 100B, 100D disable the print function (T132, T134). The print function is thus appropriately disabled.

As mentioned, the update data in the above embodiment is data used to address a vulnerability in the print function. Thus, executing printing without updating firmware is undesirable from a security perspective. Therefore, the server 10 sends the update data, immediately after acquiring it, to the printers 100A, 100C in which the print function is executed at a relatively high frequency. As a result, the firmware is updated relatively promptly in the printers 100A, 100C. Especially, since the print function is not disabled in the printers 100A, 100C, users do not have to perform an operation to remove disablement. Thus, user convenience is improved.

The server 10 does not immediately send the update data to the printers 100B, 100D in which the print function is executed at a relatively low frequency. Since the execution frequency of print function is low in the printers 100B, 100D, these printers are less likely to receive a print instruction from users even if the firmware are updated therein. The firmware need not be updated immediately if the print function is not executed. Thus, execution of the non-urgent step (i.e., firmware update) is prevented.

The printers 100B, 100D each can send the update data request to the server 10 in response to receiving selection of the update button in the notification screen SC1 from users (T142 in FIG. 3). This allows the users to update the firmware in the printers 100B, 100D right before they use the printers 100B, 100D for printing.

### Correspondence Relationships

The server 10 is an example of “server”. The printers 100A to 100D are an example of “one or more function executing devices”. Especially, the printers 100B, 100D are examples of “target function executing device”. Further, the printers 100A, 100C are an example of “other function executing devices among the one or more function executing devices other than the target function executing device”. The print function is an example of “specific function”. The log information is an example of “history information”. The disablement instruction is an example of “restriction instruction”. The message in the notification screen SC1 which indicates that the firmware in the printer 100B needs to be updated in order to remove the disablement is an example of “condition information”. The operation to select the update button in the notification screen SC1 is an example of “command related to removal of the restriction”. The update data request is an example of “restriction removal information”.

Correspondence relationships for steps executed by the “server” are as follows. T12 and T22 in FIG. 2 are examples of “receive, from each of one or more function executing devices, history information”. T112 in FIG. 3 is an example of “specify a target function executing device”. T120 is an example of “send the update data”. T130 is an example of “send a restriction instruction” and “send notification information”. T142 and T144 are examples of “receive restriction removal information” and “in a case where the restriction removal information is received from the target function executing device, send the update data”, respectively.

Correspondence relationships for steps executed by the “one or more function executing devices” are as follows. T12 and T22 in FIG. 2 are examples of “send history information”. T130 in FIG. 3 is an example of “receive a restriction instruction” and “receive notification information”. T133 is an example of “cause an output unit to output information indicating that the execution of the specific function has been restricted (and cause an output unit to output condition information)”. T142, T144, T146, T147, T148, and T149 are examples of “send restriction removal information”, “receive the update data”, “in a case where the update data is received from the server, update the software according to the update data”, “send update result information”, “receive a restriction removal instruction”, and “remove the restriction after the software has been updated”, respectively.

### Second Embodiment: FIG. 3

Referring to FIG. 3, a second embodiment is described. The second embodiment is different from the first embodiment in that the printer 100B can control whether to remove the disablement of print function. Similar to the first embodiment, the same sequence from T110 to T144 in FIG. 3 is executed in the second embodiment.

First, Case A where firmware update succeeds is described. In T146, the firmware update in the printer 100B succeeds. Thus, the firmware in the printer 100B is successfully updated. In this case, the printer 100B omits T147 and T148 and removes the disablement in T149. Thus, the printer 100B can remove the disablement of print function without receiving the disablement removal instruction from the server 10.

Next, Case B where firmware update fails is described. In Case B, the firmware update in the printer 100B fails in T150. In this case, the printer 100B maintains the disablement of print function without executing T151 and T152. Thus, the printer 100B can maintain the disablement of print function without receiving the disablement maintaining instruction from the server 10.

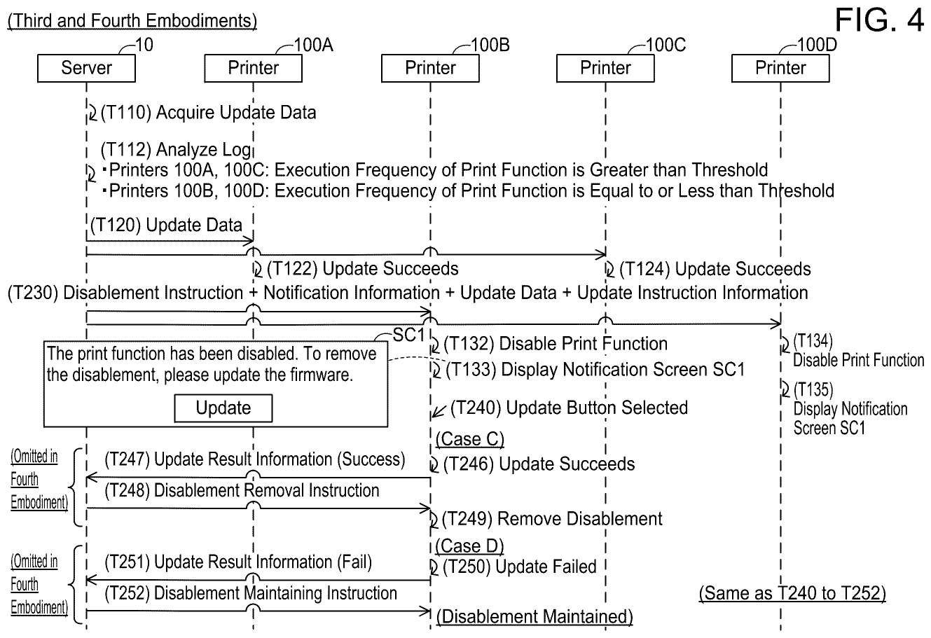

### Third Embodiment: FIG. 4

Referring to FIG. 4, a third embodiment is described. The third embodiment is different from the first embodiment in information to be sent to the two printers 100B, 100D which have been determined as having the execution frequency of print function less than or equal to the threshold. In FIG. 4, the same steps as those in FIG. 3 are labeled with the same reference signs and are not detailed again.

In T230, the server 10 sends the disablement instruction, the notification information, the update data, and update instruction information to the printers 100B, 100D. The update instruction information is information that instructs the updating of firmware according to the update data in response to the update button in the notification screen SC1 being selected. That is, the printer 100B receives the update data from the server 10 in T230, but does not update the firmware immediately.

In T230, the printer 100B receives the disablement instruction, the notification information, the update data, and the update instruction information from the server 10. In this case, the printer 100B executes T132 and T133. After that, the printer 100B receives selection of the update button in the notification screen SC1 from a user in T240. As described above, the update instruction information instructs the updating of firmware in response to the update button being selected. Thus, the printer 100B updates the firmware according to the received update data. Since the printer 100B already received the update data in T230, the printer 100B does not send the update data request to the server 10. This allows the printer 100B to start the firmware update promptly.

### Case C

In Case C, the firmware update succeeds. A sequence from T246 to T249 is the same as the sequence from T146 to T149 in FIG. 3.

### Case D

In Case D, the firmware update fails. A sequence from T250 to T252 is the same as the sequence from T150 to T152 in FIG. 3.

The sequence from T240 to T249 or T240 and the sequence from T250 to T252 are also executed between the printer 100D and the server 10. The update data and the update instruction information are examples of “update-related information”. T230 in FIG. 4 is an example of “send update-related information” by the “server” and “receive update-related information” by the “function executing device”. T246 and T249 are examples of “update the software according to the update data in response to receipt of the command related to removal of restriction” and “remove the restriction after the software has been updated” by the “function executing device”, respectively.

### Fourth Embodiment: FIG. 4

Referring to FIG. 4, a fourth embodiment is described. The fourth embodiment is different from the third embodiment in that the printer 100B can control whether to remove the disablement of print function. Similar to the third embodiment, the sequence from T110 to T124, T230, the sequence from T132 to T135, and T240 are executed in the fourth embodiment.

First, Case C where firmware update succeeds is described. In T246, the firmware update in the printer 100B succeeds. Thus, the firmware in the printer 100B is successfully updated. In this case, the printer 100B omits T247 and T248 and removes the disablement in T249. In the fourth embodiment, the printer 100B can remove the disablement of print function without receiving the disablement removal instruction from the server 10.

Next, Case D where firmware update fails is described. In Case D, the firmware update in the printer 100B fails in T250. In this case, the printer 100B maintains the disablement of print function without executing T251 and T252. In the fourth embodiment, the printer 100B can maintain the disablement of print function without receiving the disablement maintaining instruction from the server 10.

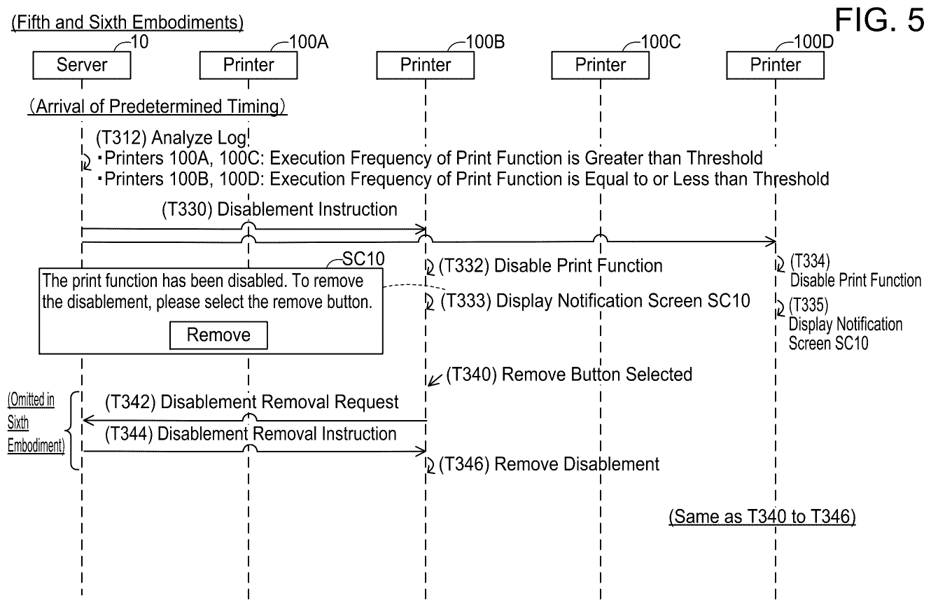

### Fifth Embodiment: FIG. 5

Referring to FIG. 5, a fifth embodiment is described. The fifth embodiment is different from the first embodiment in the timing at which the log analysis is executed using the log tables 42. In the fifth embodiment, the server 10 executes the log analysis at a predetermined time. The predetermined time is, for example, the start or end of a predetermined cycle, or when an instruction for the log analysis is received from a user. Especially, in the fifth embodiment, the server 10 executes the log analysis before acquiring the update data.

T312 in FIG. 5 is the same as T112 in FIG. 3. The server 10 does not send information to the printers 100A, 100C in which the execution frequency of print function is greater than the threshold.

In T330, the server 10 sends the disablement instruction to the printers 100B, 100D in which the execution frequency of print function is less than or equal to the threshold. T332 and T334 are the same as T132 and T134 in FIG. 3, respectively.

In T333, the printer 100B displays a notification screen SC10 on the display unit 114. The notification screen SC10 includes information indicating that the print function has been disabled. The notification screen SC10 further includes a remove button for removal of the disablement. T335 is the same as T333 except that it is the printer 100D that displays the screen.

In T340, the printer 100B receives selection of the remove button in the notification screen SC10 from a user. In this case, the printer 100B sends a disablement removal request to the server 10 in T342. The disablement removal request is a signal that requests the disablement of print function to be removed.

In T342, the server 10 receives the disablement removal request from the printer 100B. In response, the server 10 sends the disablement removal instruction to the printer 100B in T344.

In T344, the printer 100B receives the disablement removal instruction from the server 10. In this case, the printer 100B removes the disablement in T346. The printer 100D executes the same sequence as the sequence from T340 to T346. As described above, users can remove the disablement of print function in the printers 100B, 100D by selecting the remove button. The selection of the remove button in the notification screen SC10 is an example of “command for removing the restriction”. T346 in FIG. 5 is an example of “remove restriction in a case where a command for removing the restriction is received” by the “function executing device”.

### Sixth Embodiment: FIG. 5

Referring to FIG. 5, a sixth embodiment is described. The sixth embodiment is different from the fifth embodiment in that the printer 100B can control whether to remove the disablement of print function. Similar to the fifth embodiment, the same sequence from T312 to T335 in FIG. 5 is executed in the sixth embodiment.

In T340, the printer 100B receives selection of the remove button in the notification screen SC10 from a user. In this case, the printer 100B removes the disablement in T346 without sending the disablement removal request to the server 10. In the sixth embodiment, the printer 100B can remove the disablement of print function without receiving the disablement removal instruction from the server 10.

(Modification 1) The above embodiments describe examples in which the print function is disabled based on the execution frequency of print function. In a modification, for example, based on an access frequency to a printer functioning as a web server, access to the web server may be disabled. In this modification, the web server function is an example of “specific function”. Besides this, the “specific function” may be a facsimile function or a function for encrypted communication. Generally, the “specific function” can be any function that can be executed by the “function executing device”.

(Modification 2) In the above embodiments, the print function is disabled in printers in which the execution frequency of print function is less than or equal to the threshold. Instead of this, for example, a part of the print function may be disabled in printers in which the execution frequency of print function is less than or equal to the threshold, while the rest of the print function may not be disabled. For example, communication of print data may be disabled, while printing itself may not be disabled. For example, a printer may not be permitted to receive print data from a terminal and execute printing, while the printer may be permitted to execute printing through the operation unit 114 of the printer (e.g., copy). In this modification, the disablement of a part of the function and non-disablement of the rest of the function is an example of “restricting execution of the specific function”.

(Modification 3) The server 10 may not send the notification information to the printer 100B in T130 of FIG. 3. In this case, the printer 100B may not display the notification screen SC1. In this modification, “send notification information” by the “server” and “receive notification information” by the “function executing device” may be omitted. Further, “cause an output unit to output information indicating that the execution of the specific function has been restricted” and “cause an output unit to output condition information” by the “function executing device” may be omitted.

(Modification 4) In T140 of FIG. 3, the printer 100B may receive an operation for removing the disablement, instead of receiving selection of the update button. The operation for removing the disablement is, for example, an operation through the operation unit 114. In this case, the printer 100B may send information indicating receipt of the operation for removing the disablement to the server 10 in T142. In response, the server 10 may send the update data to the printer 100B. In this modification, the operation for removing the disablement is an example of “command related to removal of restriction”. Further, the information indicating receipt of the operation for removing the disablement is an example of “restriction removal information”.

(Modification 5) The printers 100B, 100D may not display the notification screen SC1. In this case, the server 10 may send the notification information to a terminal device in T130 of FIG. 3, instead of sending the notification information to the printers 100B, 100D. In this case, the notification screen SC1 may be displayed at the terminal device. In this case, the notification screen SC1 may include information indicative of printers in which the print function has been disabled (e.g., serial numbers of such printers). Then, in response to receiving selection of the update button in the notification screen SC1 from a user, the terminal device may send information indicating the selection of the update button to the printers 100B, 100D. In response to receiving this information, the printer 100B may send the update data request to the server 10 in T142. In this modification, the information indicating the selection of the update button from the terminal device is an example of “command related to removal of restriction”. Similarly, the printers 100B, 100D may not display the notification screen SC10. In this case, the notification screen SC10 may be displayed at the terminal device. Then, in response to receiving selection of the remove button in the notification screen SC10 from the user, the terminal device may send information indicating the selection of the remove button to the printers 100B, 100D. In response to receiving this information, the printer 100B may send the disablement removal request to the server 10 in T342. In this modification, the information indicating the selection of the remove button from the terminal device is an example of “command related to removal of restriction”.

(Modification 6) In the above embodiments, the steps in FIGS. 3 to 5 are implemented by software (e.g., the programs 36, 136). However, at least one of the steps may be implemented by hardware such as a logic circuit.

What is claimed is:

1. A server comprising a controller,
wherein the controller is configured to:
receive, from one or more function executing devices, history information representing an execution history of a specific function executable by each of the one or more function executing devices;
determine a target function executing device from among the one or more function executing devices based on the history information received from each of the one or more function executing devices, wherein the target function executing device has an execution frequency of the specific function that is less than or equal to a predetermined threshold, the execution frequency being a frequency at which the specific function is executed; and
send a restriction instruction, for imposing a restriction on execution of the specific function, to the target function executing device, wherein the restriction instruction is not sent to other function executing devices except for the target function executing device among the one or more function executing devices.

2. The server as in claim 1, wherein
in a case where update data is acquired from an external, the controller is configured to determine the target function executing device, and
the update data is data for updating software corresponding to the specific function.

3. The server as in claim 2, wherein
the controller is further configured to send the update data to the other function executing devices, and
the update data is not sent to the target function executing device.

4. The server as in claim 2, wherein
the controller is further configured to send notification information, for indicating that the software is updatable, to the target function executing device, and
the notification information is not sent to the other function executing devices.

5. The server as in claim 4, wherein
the controller is further configured to:
in a case where the target function executing device receives a command related to removal of the restriction after the notification information has been sent to the target function executing device, receive restriction removal information related to removal of the restriction from the target function executing device; and
in response to receiving the restriction removal information from the target function executing device, send the update data to the target function executing device.

6. The server as in claim 2, wherein
the controller is further configured to send, to the target function executing device, update-related information related to updating of the software, the update-related information including the update data and update instruction information, the update instruction information being for instructing the updating of the software according to the update data in response to receipt of a command related to removal of the restriction.

7. A function executing device comprising a controller,
wherein the controller is configured to:
send, to a server, history information representing an execution history of a specific function executable by the function executing device;
in a case where the server determines that an execution frequency of the specific function, which is a frequency at which the specific function is executed, is less than or equal to a predetermined threshold based on the history information, receive a restriction instruction, for imposing a restriction on execution of the specific function, from the server; and
in response to receiving the restriction instruction from the server, restrict execution of the specific function.

8. The function executing device as in claim 7, wherein
the controller is further configured to, in a case where the execution of the specific function is restricted, cause an output unit to output information indicating that the execution of the specific function has been restricted.

9. The function executing device as in claim 7, wherein
the controller is further configured to:
in a case where the server acquires update data from an external, receive notification information from the server, wherein the update data is data for updating software corresponding to the specific function, and the notification information is information for indicating that the software is updatable; and
in a case where the notification information is received from the server, cause an output unit to output condition information, wherein the condition information indicates that the restriction is removable on condition that the software is updated.

10. The function executing device as in claim 9, wherein
the controller is further configured to:
in response to receiving a command related to removal of the restriction, send restriction removal information related to removal of the restriction to the server;
receive the update data from the server after the restriction removal information has been sent to the server;
in response to receiving the update data from the server, update the software according to the update data; and
remove the restriction after the software has been updated.

11. The function executing device as in claim 10, wherein
the controller is further configured to:
send, to the server, update result information indicating that the software was updated after the software has been updated;
receive a restriction removal instruction from the server after sending the update result information to the server, and
remove the restriction in response to receiving the restriction removal instruction from the server.

12. The function executing device as in claim 7, wherein
the controller is further configured to:
in a case where the server acquires update data from an external, receive update-related information related to updating of software from the server, the update data being for updating the software corresponding to the specific function, the update-related information including the update data and update instruction information, the update instruction information being for instructing the updating of the software according to the update data in response to receipt of a command related to removal of the restriction;
update the software according to the update data in response to receipt of the command related to removal of the restriction; and
remove the restriction after updating the software.

13. The function executing device as in claim 7, wherein
the controller is further configured to remove the restriction in a case where a command for removing the restriction is received after execution of the specific function has been restricted in response to receipt of the restriction instruction from the server in a situation where the server does not obtain update data.

14. A communication system comprising:
a server; and
one or more function executing devices,
wherein each of the one or more function executing devices comprises a device controller configured to send history information representing an execution history of a specific function executable by the function executing device to the server,
wherein the server comprises a server controller configured to:
receive the history information from each of the one or more function executing devices;
determine a target function executing device from among the one or more function executing devices based on the history information received from each of the one or more function executing devices, wherein the target function executing device has an execution frequency of the specific function that is less than or equal to a predetermined threshold, the execution frequency being a frequency at which the specific function is executed; and
send a restriction instruction, for restricting execution of the specific function, to the target function executing device, wherein the restriction instruction is not sent to other function executing devices except for the target function executing device among the one or more function executing devices, and
wherein the target function executing device comprises a target device controller configured to:
receive the restriction instruction from the server; and
in response to receiving the restriction instruction from the server, restrict execution of the specific function.

15. A non-transitory computer-readable storage medium storing computer-readable instructions for a server,
wherein the computer-readable instructions, when executed by a processor of the server, cause the server to:
receive, from one or more function executing devices, history information representing an execution history of a specific function executable by each of the one or more function executing devices;
determine a target function executing device from among the one or more function executing devices based on the history information received from each of the one or more function executing devices, wherein the target function executing device has an execution frequency of the specific function that is less than or equal to a predetermined threshold, the execution frequency being a frequency at which the specific function is executed; and
send a restriction instruction for restricting execution of the specific function to the target function executing device, wherein the restriction instruction is not sent to other function executing devices except for the target function executing device among the one or more function executing devices.

16. A non-transitory computer-readable storage medium storing computer-readable instructions for a function executing device,
wherein the computer-readable instructions, when executed by a processor of the function executing device, cause the function executing device to:
send history information representing an execution history of a specific function executable by the function executing device to a server;
in a case where the server determines that an execution frequency of the specific function, which is a frequency at which the specific function is executed, is less than or equal to a predetermined threshold based on the history information, receive a restriction instruction for restricting execution of the specific function from the server; and
in response to receiving the restriction instruction from the server, restrict execution of the specific function.
